(19) United States
(12) Patent Application Publication
(10) Pub. No.: US 2026/0163234 A1
(43) Pub. Date: Jun. 11, 2026

(54) ANTI-JAMMING DEVICE HAVING A SINGLE ANTENNA

(71) Applicant: Safran Electronics & Defense, PARIS (FR)

(72) Inventors: Alain Michel CHIODINI, MOISSY-CRAMAYEL (FR); Arnaud LILBERT, MOISSY-CRAMAYEL (FR)

(73) Assignee: Safran Electronics & Defense, PARIS (FR)

(21) Appl. No.: 18/707,278

(22) PCT Filed: Nov. 3, 2022
(86) PCT No.: PCT/FR2022/052075

§ 371 Date: May 3, 2024

(30) Foreign Application Priority Data
Nov. 4, 2021 (FR) FR2111669

(51) Int. Cl. H01Q 1/42

(52) U.S. Cl. CPC H01Q 1/425

(57) ABSTRACT

The invention relates to an anti-jamming antenna device comprising: an antenna having a uniform radiation pattern; a mesh structure (3) covering the antenna, said mesh structure being configured to modify the radiation pattern of the antenna so as to generate and to orient at least one lobe and/or gain slot in at least one direction of interest.

### TECHNICAL FIELD

The invention relates to the removal of interference in signals received by a receiver in a Global Navigation Satellite System (GNSS).

### PRIOR ART

Global Navigation Satellite Systems—or GNSS systems (GPS, GALILEO, GLONASS) operate on radiofrequency bands dedicated to this use on the L-band (i.e. between 1 and 2 GHz). Like any radio receiver, they are likely to be accidentally or intentionally jammed. Given use in particular to facilitate transports (by sea, river, land, and air) and to allow the proper conducting of industrial, scientific, and military applications, the jamming thereof can jeopardize the civil population, industrial processes, and military personnel on missions. Adequate anti-jamming solutions should therefore be deployed wherever needed.

Said anti-jamming solutions are based on a spatial processing device comprising a Controlled Radiation Pattern Antenna (CRPA) positioned upstream of the GNSS receiver and intended to mitigate the negative impact of jammers on the performance of the receiver.

The two major spatial processing techniques used to date are the following:
Gain notching in the angular space in the direction of jammers («null steering»)
Optimized reception of GNSS signals of interest by means of spatial filtering («beam forming»)

A CRPA system of known type comprises as many receive paths as there are antenna elements forming the antenna array.

In particular, the signals arriving from the different antenna elements of the CRPA antenna are weighted by amplitude and phase before being summed to form a single signal, expunged of jamming signals, fed into the GNSS receiver. Irrespective of the processing used, the analog functions required for the receiving of signals up to conversion thereof to digital signals, have to be multiplied by the number of antenna elements and by the number of frequency bands of the constellations processed by the receiver.

In addition, this multiplicity of frequency bands processed by the analog functions, between each of the corresponding analog receive paths, introduces gain and phase dispersion due to the variability of the physical parameters characterizing the constituent components and links of the latter. This dispersion, by corrupting the spatial signal perceived by the physical antenna array, strongly contributes towards degrading performance in estimating the direction of arrival of jammers.

It is known from the prior art that a gain and phase calibration device can be used to compensate for these dispersions between the receive paths. However, for this calibration device to be most efficient, it must take into account all the elements of the receive paths including the unit antennas of the array. This requires the adding of complex auxiliary functions:
Generating calibration signals in conducted or radiated mode.
Analog/digital measurement of gain and phase differences between the paths.
Analog/digital compensation for estimated gain and phase differences.

This all leads to an increase in surface area, in consumption and costs of the GNSS receiver for which an anti-jamming solution of CRPA type is to be developed.

### SUMMARY OF THE INVENTION

The invention sets out to solve the problem of surface area/consumption/cost intrinsically related to the prior art for the development of an anti-jamming solution of CRPA type, and to obviate the need for the gain and phase calibration device.

For this purpose, it proposes an anti-jamming antenna device comprising:
an antenna having a uniform radiation pattern;
a mesh structure covering the antenna, said mesh structure being configured to modify the radiation pattern of the antenna to generate and orient at least one lobe and/or gain notch in at least one direction of interest.

The invention is advantageously completed with the following characteristics taken alone or in any technically possible combination:
the device comprises a radome supporting the mesh structure;
the mesh structure is printed on the radome;
the mesh structure is formed of a material configured to switch from a conductive state to an insulating state, and conversely;
the material is neodymium-nickel oxide;
the mesh structure comprises a plurality of unit cells, the unit cell being adapted to the wavelength of the signals that the antenna is to capture.

The invention also concerns a receiver comprising an anti-jamming antenna device of the invention having a control unit configured to modify the pattern of the antenna.

It is proposed to replace the array composed of M antenna elements by a single antenna equipped with a radome having a surface that is uniformly meshed by an array of active elements allowing the transition from a conductive state to an insulating state (and conversely). The meshing of this radome allows modification of the antenna radiation pattern to generate and dynamically orient at least one lobe and/or gain notch in at least one direction of interest (GNSS satellite/jammer).

This solution therefore allows a return to a single-path system of FRPA type (Fixed Reception Pattern Antenna) with the possibility of performing known pre- or post-correlation anti-jamming processing (frequency excision, Amplitude Domain Processing, etc.). Since the proposed solution no longer comes under a multi-path system, the calibration device therefore becomes obsolete.

A CRPA system of known type comprises as many receive paths as there are antenna elements forming the antenna array. Each antenna element is associated with a radiofrequency (RF) signal processing chain up until digitization thereof. Through the use of a dynamically configurable structure, the invention replaces a multiplicity of antenna elements and associated receive paths by a single antenna and a single receive path.

### PRESENTATION OF THE FIGURES

Other characteristics, objectives, and advantages of the invention will become apparent from the following nonlimiting description which is solely illustrative and is to be read in connection with the appended drawings in which:

FIG. 1 illustrates a GNSS receiver conforming to the invention;

FIG. 2 illustrates a mesh structure conforming to one embodiment of the invention;

FIG. 3 illustrates a mesh structure conforming to one embodiment of the invention;

FIG. 4 and FIG. 5 illustrate radiation patterns obtained with the invention.

In all the Figures, similar elements carry same references.

### DETAILED DESCRIPTION

### GNSS Receiver

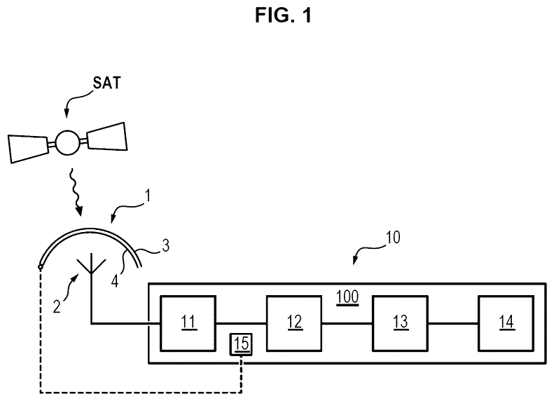

FIG. 1 illustrates a GNSS receiver 10 comprising an antenna 2 of patch type for example. The GNSS signals received by the antenna are transmitted to a processing unit 100 comprising several successive stages. A processing unit is a processor for example configured to implement different signal processing operations.

An incident signal is received by the antenna connected to a radio unit 11 allowing signal filtering, amplification and transposing to an intermediate frequency lower than the carrier frequency of the received signal. The signals are then digitized by an analog/digital conversion unit 12. Each converter provides digital samples containing navigation information (useful data), optionally residual jamming components further to mitigation by the anti-jamming device (described below), and noise inherent in any radio transmission.

The signal is then sent to a unit 14 allowing computing of the navigation data (not described herein since well-known to skilled persons).

### Anti-Jamming Device

The antenna 2 of the receiver 10 belongs to an antenna device which comprises the antenna 2 as such and a mesh structure 3 covering the antenna 2.

The antenna 2 is an antenna having a uniform radiation pattern. The pattern is uniform in that it does not give priority to any direction.

The mesh structure allows modifying of the antenna radiation pattern to generate and dynamically orient at least one lobe and/or gain notch in at least one direction of interest (GNSS satellite/jammer).

Preferably, the mesh structure is supported by a radome 4. A radome is a known structure that is electromagnetically impervious in that it does not itself perturb the functioning of the antenna. Usually, a radome is a waterproof protective shelter used to protect an antenna against bad weather and also against observant scrutiny since the shape thereof hides the orientation of the antenna. Various materials can be used for the radome but they have in common that they do not perturb the functioning of the antenna. There are rigid radomes and others that are flexible made of fabric and inflatable. They can have different shapes which vary according to use.

### Mesh Structure

The mesh structure is composed of active elements allowing transition from a conductive state to an insulating state (and conversely).

The active elements are particularly composed of a material configured to switch from a conductive state to an insulating state, and conversely. For example, the mesh structure is printed on the radome 4 which acts as support.

To trigger this transition, the mesh structure is connected to a control unit 15 (which here preferably belongs to the GNSS receiver although this is not compulsory).

Preferably, the mesh structure is composed of neodymium-nickel oxide, a material which, depending on temperature, is at times a metal and at times an insulator. In this respect, the control unit 15 allows regulation of the temperature of the structure. For example, neodymium-nickel oxide transitions in the region of −123° C. (150 K): above this temperature it is metallic, below it is insulating.

Other materials are possible provided they have the property of switching from a conductive state to an insulating state and conversely, or any other material allowing a change in insulating/conductive property as a function of a physical parameter or any other property.

The «conductor-to-insulator» transition of the active elements allows the forming of unit cells of different patterns and different sizes:
When all the elements of the array are insulating, the radome has radiofrequency transparency and therefore does not modify the radiation pattern particular to the antenna.
When the insulator-to-conductor transition is activated, two situations can occur:
   The transition of the entire array causes the radome to become opaque to radiofrequency and can fulfil the function for example of mitigating the signals in all directions—known as blanking;
   Partial transition of the array modifies the radiation pattern particular to the antenna to generate and dynamically orient at least one lobe and/or gain notch in at least one direction of interest. Adaptation of the size of conducting unit cells allows orienting of the radiation pattern of the antenna.

The overall performance obtained depends on the coupling between the meshed radome and the antenna. This coupling is impacted by the parameters particular to the mesh structure and to the antenna:
Parameters particular to the meshed radome:
   3D geometry of the radome (hemispherical, parabolic, planar, etc.);
   Size of mesh unit cell (the smallest obtainable) representing the wavelength of the captured signals, and the juxtaposing of which allows the forming of a surface that is electromagnetically opaque to the frequency band it is desired to mitigate (jamming signals).
Parameters particular to the antenna:
   Type of antenna (dipole, patch, etc.);
   Polarization of the antenna;
   Coordinates of the injection point of the antenna corresponding to the coordinates X and Y of the position, for a patch antenna, at which the antenna connector is positioned.

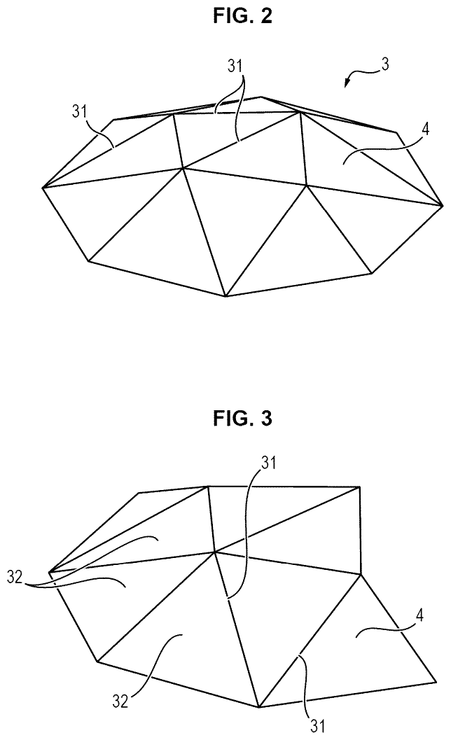

FIG. 2 illustrates a mesh structure comprising active elements 31 forming triangular unit cells. The unit cells can be of several shapes: oval, hexagonal, circular, rectangular, etc.

FIG. 3 illustrates an antenna of circular microstrip patch type comprising a radome supporting the mesh structure. The principle of unit cell juxtaposition allows the forming of an assembly of surfaces 32 that are electromagnetically opaque to the frequency band it is desired to mitigate (jamming signals). It is formed from a «solid» triangular surface.

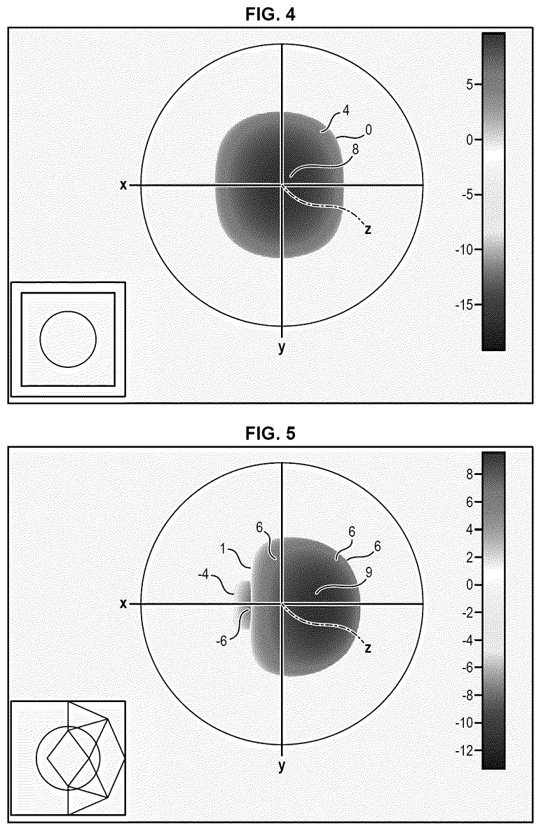

FIG. 4 is an overhead view of the 3D radiation pattern of the antenna in FIGS. 2 and 3 when all the active elements of the array are insulating: the mesh structure (and hence the radome) is transparent to radiofrequency. This pattern is therefore equivalent to that of an antenna without a mesh structure and has near-uniform gain in the azimuth plane (no direction has priority). At the bottom left of this Figure, it can be seen that the mesh structure is transparent.

FIG. 5 is an overhead view of the 3D radiation pattern of the antenna in FIGS. 2 and 3 when some of the active elements of the array are conductive. This pattern has pronounced anisotropy, thereby giving priority to a particular direction (whilst maintaining the maximum gain obtained in the «transparent radome» configuration in FIG. 3) and hence mitigating the jamming signals in the opposite region by about 10 dB. At the bottom left of this Figure, the shape of the mesh structure can be seen.

1. An anti-jamming antenna device comprising:
an antenna having a uniform radiation pattern;
a mesh structure covering the antenna, the mesh structure being configured to modify the radiation pattern of the antenna to generate and to orient at least one lobe and/or gain notch in at least one direction of interest, the mesh structure is formed of a material configured to switch from a conductive state to an insulating state, and conversely.

2. The device according to claim 1, comprising a radome supporting the mesh structure.

3. The device according to claim 2, wherein the mesh structure is printed on the radome.

4. The device according to claim 1, wherein the material is neodymium-nickel oxide.

5. The device according to claim 1, wherein the mesh structure comprises a plurality of unit cells, the unit cell being adapted to the wavelength of the signals that the antenna is to capture.

6. A receiver comprising an anti-jamming antenna device according to claim 1, comprising a control unit configured to modify the pattern of the antenna.

7. The device according to claim 2, wherein the material is neodymium-nickel oxide.

8. The device according to claim 3, wherein the material is neodymium-nickel oxide.
